(19) United States
(12) Patent Application Publication
(10) Pub. No.: US 2024/0075835 A1
(43) Pub. Date: Mar. 7, 2024

(54) PEDESTAL BASE FOR AN ELECTRIC VEHICLE CHARGER WITH A BUILT IN PEDESTAL

(71) Applicant: SHOALS TECHNOLOGIES GROUP, LLC, Portland, TN (US)

(72) Inventors: Dorothy MICHAEL, Greenbrier, TN (US); Steven P. GREENWELL, Portland, TN (US); Kevin BOYCE, Brentwood, TN (US)

(21) Appl. No.: 18/456,277

(22) Filed: Aug. 25, 2023

Related U.S. Application Data
(60) Provisional application No. 63/374,315, filed on Sep. 1, 2022.

(51) Int. Cl. B60L 53/31; B60L 53/18

(52) U.S. Cl. CPC B60L 53/31; B60L 53/18

(57) ABSTRACT

A pedestal base may include a skid base and a cover. The skid base may define an opening. The skid base may interface with a cable management system (CMS) via the opening. The cover may mechanically interface with an electric vehicle (EV) charger. The cover may also mechanically interface with the skid base. The skid base and the cover may define a volume. The skid base and the cover, when mechanically interfaced, may permit a cable to extend between the CMS and the EV charger and to extend through the opening and the volume.

### CROSS-REFERENCE TO RELATED APPLICATION

This patent application claims the benefit of and priority to U.S. Provisional App. No. 63/374,315 filed Sep. 1, 2022, titled “PEDESTAL BASE FOR AN ELECTRIC VEHICLE CHARGER WITH A BUILT IN PEDESTAL,” which is incorporated in the present disclosure by reference in its entirety.

### FIELD

Embodiments described in the present disclosure relate to a pedestal base for an electric vehicle charger with a built-in pedestal.

### BACKGROUND

Unless otherwise indicated in the present disclosure, the materials described in the present disclosure are not prior art to the claims in the present application and are not admitted to be prior art by inclusion in this section.

Typical electric vehicles (EVs) operate on large on-board energy storage cells or rechargeable batteries. EV battery capacity limits the distances EVs can travel on a single charge from and/or between a user's home EV charger system and commercial EV charger systems (e.g., charging stations). Commercial EV charger infrastructure has historically included sparsely located EV charger systems at haphazard or ad hoc locations. The sparsity of commercial EV charger infrastructure is an impediment to the widespread adoption of EVs.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a pedestal base may include a skid base and a cover. The skid base may define an opening. The skid base may interface with a cable management system (CMS) via the opening. The cover may mechanically interface with an EV charger. The cover may also mechanically interface with the skid base. The skid base and the cover may define a volume. The skid base and the cover, when mechanically interfaced, may permit a cable to extend between the CMS and the EV charger and to extend through the opening and the volume.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of an example EV charger system;

FIGS. 2A and 2B illustrate an example pedestal base that may be implemented in the system of FIG. 1;

FIG. 3 illustrates another example pedestal base that may be implemented in the system of FIG. 1;

FIGS. 4A, 4B, 4C, and 4D illustrate example cable management systems that may be included in the system of FIG. 1; and

FIG. 5 illustrates a flowchart of an example method of assembling a pedestal base,

all arranged in accordance with at least one embodiment described herein.

### DESCRIPTION OF EMBODIMENTS

Approximately half of an EV charger system infrastructure deployment cost is associated with temporal aspects of the deployment: power entry equipment, cables, skids, extensive civil work, and long cable runs and connectors. To meet EV deployment goals, charge point operators need to speed deployment while simultaneously reducing costs.

The EV charger system may include one or more EV chargers configured to provide power to EVs. Various EV chargers may include different mounting configurations to mechanically interface with a pedestal base of the EV charger system. For example, different EV chargers may interface with a different mechanical interface (e.g., a different hole pattern), a different wiring configuration, or some combination thereof to attach the EV chargers to the pedestal base. The deployment costs associated with these EV charger systems may increase due to the pedestal bases being individually manufactured to only be compatible with a particular EV charger. The pedestal bases may include unique mechanical interfaces that are compatible with a limited number of EV chargers (e.g., a single EV charger). These and other pedestal bases may increase deployment costs of EV charger systems.

Some embodiments described in the present disclosure may include a universal pedestal base to which a variety of EV chargers may be mounted. The pedestal base may include a skid base and multiple covers to permit different EV chargers to mechanically interface with (e.g., attach to) the pedestal base. In addition, the pedestal base may include one or more overcurrent devices or fuse devices to prevent an overcurrent condition (e.g., an overload condition) or a short circuit condition from occurring at the EV chargers.

In some embodiments, the pedestal base may be configured to mechanically interface with (e.g., attach to) an EV charger that includes a built-in pedestal. Each of the covers may include a different mechanical interface and/or other features (e.g., depressions, protrusions, tabs, threads, mounting brackets, or the like) to accommodate a different mounting configuration. In some embodiments, the covers may include multiple mechanical interfaces to accommodate multiple EV chargers. The pedestal base may include a standardized configuration to permit standardized wiring configurations for different EV charger mounting dimensions. In addition, the pedestal base may permit at least a portion of the EV charger system (e.g., the pedestal base, one or more CMS s, a power platform, or some combination thereof) to be installed above ground.

The pedestal base may include the skid base and the cover. The skid base may define an opening. The skid base may interface with the CMS via the opening. The cover may mechanically interface with the EV charger. The cover may also mechanically interface with the skid base. The skid base and the cover may define a volume. Additionally, the skid base and the cover, when mechanically interfaced, may permit a cable to extend between the CMS and the EV charger and to extend through the opening and the volume.

The pedestal base may include multiple covers and the skid base. Each of the covers may include a different mechanical interface configured to permit a different EV charger to be attached to a surface of a corresponding cover. The skid base may be configured to interface with each of the covers. The skid base and each of the covers, when mechanically interfaced with the skid base, may define the volume. The skid base and each of the covers, when mechanically interfaced, may permit the cable of the CMS to extend between the CMS and the EV charger and to extend through the volume.

Embodiments described herein relate to a pedestal base that may reduce deployment costs (e.g., installation times and/or overall costs) of an EV charger system. The pedestal base described herein may include modular components that cost less, use less site preparation prior to installation of an EV charger system, are readily portable, and/or offer availability to change scale in an amount of EV chargers supported.

The pedestal base described in the present disclosure may interface with the CMS, a lead assembly (e.g., a big lead assembly (BLA)), or some combination thereof to standardize installation of EV charger systems, install the EV charger system above ground, or some combination thereof.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

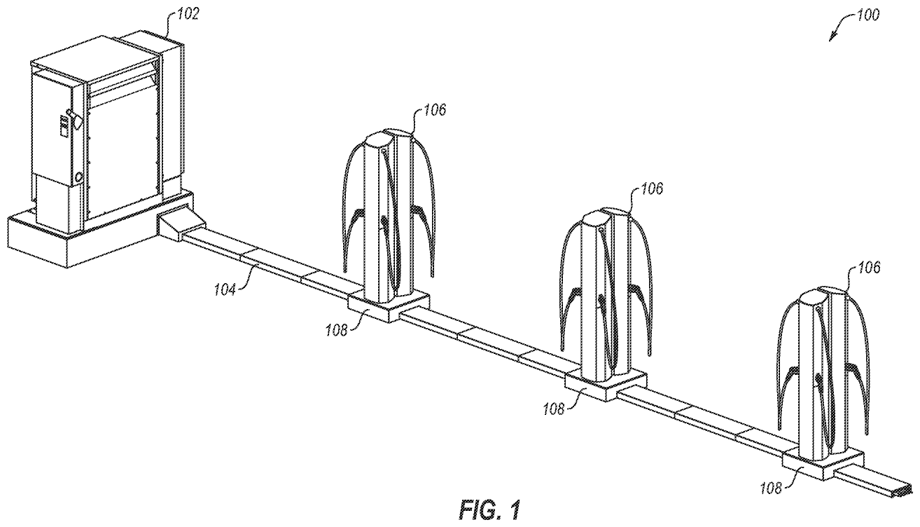

FIG. 1 illustrates a perspective view of an example EV charger system 100 (hereinafter “system 100”) that includes a power platform 102, a CMS 104, two or more lead assemblies and/or other wiring (not illustrated in FIG. 1), and one or more charger platforms 106 (generally referred to herein as “charger platforms 106”) arranged in accordance with at least one embodiment described herein. The power platform 102 may be coupled to a power source (not illustrated in FIG. 1). The power platform 102 may be configured to transform power or otherwise condition power from the power source for compatibility with EVs and/or the charger platforms 106.

The charger platforms 106 may be electrically coupled through the lead assemblies to the power platform 102. Each of the charger platforms 106 may include one or more EV chargers, which may include, be included in, or correspond to other EV chargers herein. In some embodiments, the EV chargers may be configured to electrically couple to a vehicle or to any other device that may be configured to receive power from the system 100. As illustrated in FIG. 1, each charger platform 106 includes four EV chargers. Alternatively, or additionally, each charger platform 106 may include more or less EV chargers than illustrated. For example, the charger platforms 106 may include one, two, three, four, six, nine, or any other number of EV chargers. In these and other embodiments, each of the charger platforms 106 may be installed at an intersection of four vehicle parking spots or stalls to allow up to four EVs to be charged simultaneously through the charger platforms 106. In instances in which the charger platforms 106 include more than four EV chargers, additional EVs and/or devices may be charged simultaneously with the EVs. For example, an electric motorcycle, a portable battery supply, and/or other devices may be charged concurrently with up to four EVs as the other devices may be sized to fit between the charging EVs.

The CMS 104 may extend between the power platform 102 and at least one of the charger platforms 106 and/or between two charger platforms 106 to house and secure the lead assemblies. The CMS 104 may eliminate the need for trenching as required in some other EV charger systems as the lead assemblies may be installed above ground and protected within the CMS 104. Although illustrated in FIG. 1 as being routed on the ground or floor (e.g., of a parking lot, parking structure, or the like), more generally the CMS 104 may be routed on any installation surface or structure, such as a floor, a wall, a ceiling, or other installation surface.

The power platform 102 may be configured to receive input power (e.g., from the power source), and generate output power for operation of the charger platforms 106. For example, the power platform 102 may receive and transform an input power having a first current and voltage to an output power having a second current and voltage that is different from the first current and voltage.

In some embodiments, the system 100 may be a direct current (DC) powered system. For example, one lead assembly may be a positive lead assembly connected to a positive lead of each charger platform 106 and another lead assembly may be a negative lead assembly connected to a negative lead of each charger platform 106. In some embodiments, the system 100 may be an alternating current (AC) powered system. For example, the lead assemblies may be arranged to support single phase AC power (e.g., using a first lead assembly and a second lead assembly) and/or arranged to support three phase AC power (e.g., using a first lead assembly, a second lead assembly, a third lead assembly, and a neutral line).

Instead of or in addition to transforming voltage, the power platform 102 may convert AC input power to DC output power, in which case the power platform 102 may be or include an AC-to-DC converter, or may convert DC power to AC power, in which case the power platform 102 may be or include a DC-to-AC converter. In some embodiments, the output power may be or include DC power to charge batteries, such as EV batteries. In some embodiments, the output power may be or include AC power provided to the charger platforms 106. In these embodiments, the charger platforms 106 may convert the AC power to DC power to charge EV batteries.

In some embodiments, the power platform 102 may be configured to perform a transformation of an input power to an output power. For example, an input AC power may be received having a first voltage and current and the power platform 102 may convert the input AC power to an output AC or DC power having a second voltage and current that are different than the first voltage and current. In these and other embodiments, the power platform 102 may be electrically coupled to and receive input power from the power source, which may include a solar array, an electrical grid, or other power source. In some embodiments, the power platform 102 may include an EATON 300 kilovolt-ampere (kVA) general purpose ventilated transformer (item number V48M28T33EE) having a primary voltage of 480 volts (V) and a secondary voltage of Y/120 V. The forgoing transformer is provided only as an example, as the transformer of the power platform 102 may include any other transformer which may include the same or different primary voltage, secondary voltage, make, and/or model.

In some embodiments, the lead assemblies may each include a feeder cable, one or more drop lines, one or more drop line connectors, and/or one or more in-line fuses. Alternatively, or additionally, the lead assemblies may include one or more load side breakers and/or in-line fuses (e.g., electrically coupled between the feeder cable and the drop lines) to electrically protect the drop lines and the chargers. Each lead assembly may be configured to transmit the output power from the power platform 102 to the charger platforms 106 or return current from the charger platforms 106 to the power platform 102.

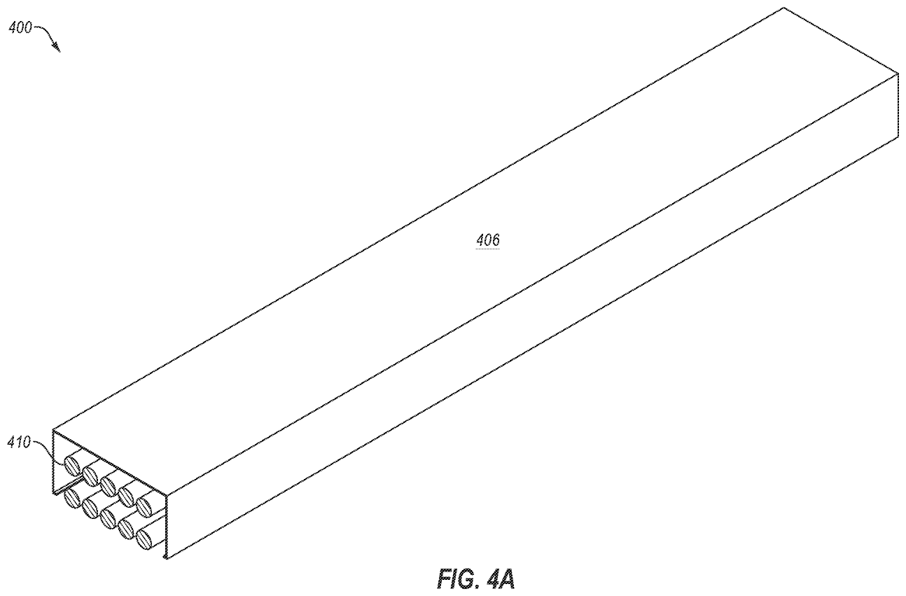

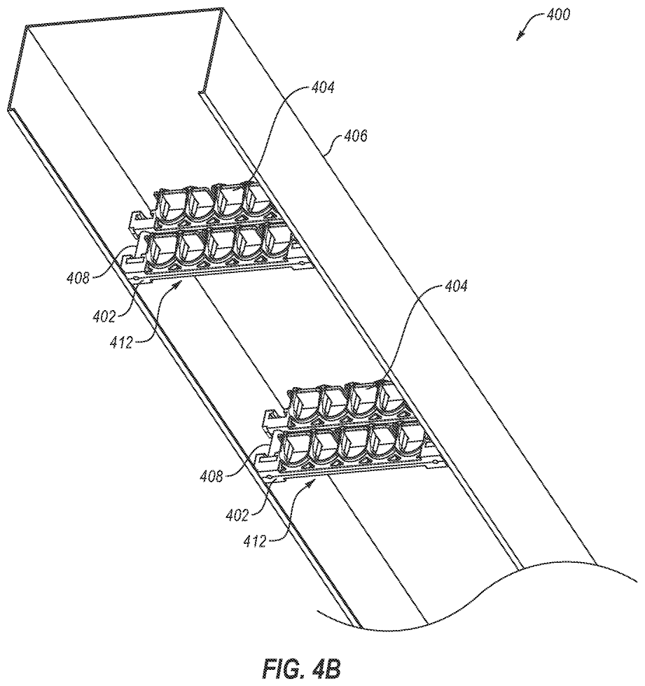

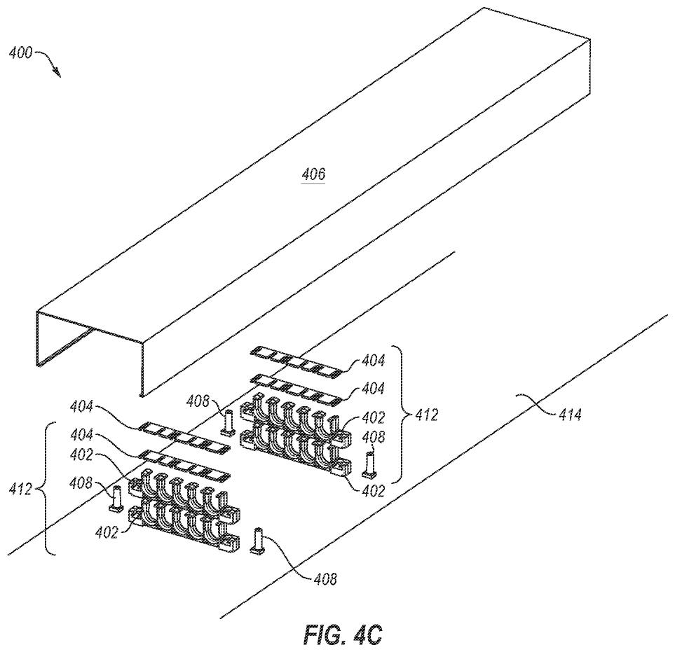

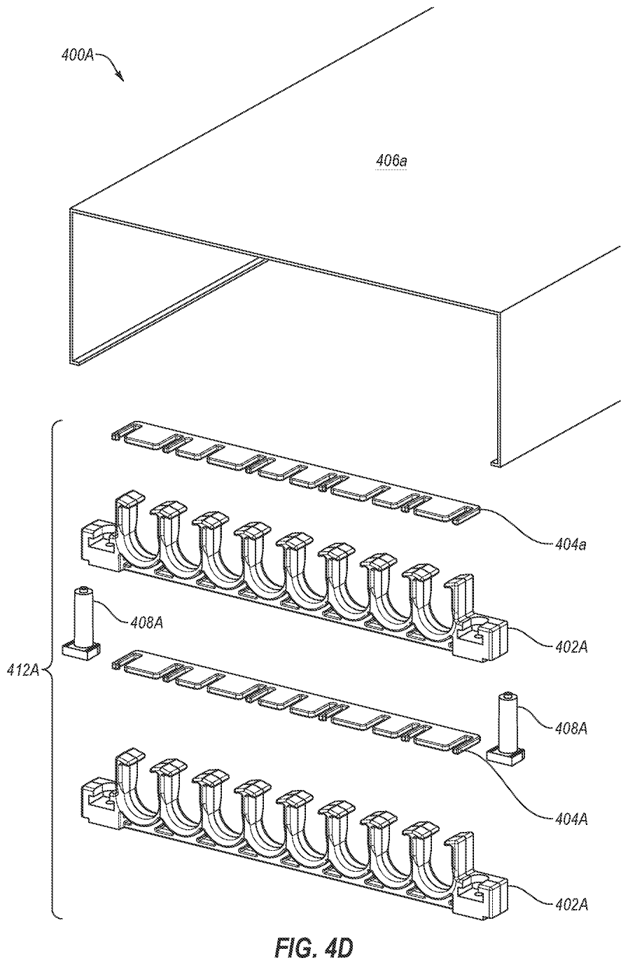

In some embodiments, the CMS 104 may extend from the power platform 102 to the charger platforms 106 or between the charger platforms 106 in a continuous trajectory and/or on the same surface on which the power platform 102 is installed or located. For example, the CMS 104 may extend on a surface on which the power platform 102 is located, and from the power platform 102 to the charger platforms 106. Alternatively, or additionally, one or more raceways included in the CMS 104 may include corners, bends, curves, etc., in extending between the power platform 102 and the charger platforms 106. For example, the power platform 102 may be installed on a garage floor, the charger platform 106 may be disposed on the garage wall, and a raceway of the CMS 104 may include a bend, curve, 90-degree turn, or the like to transition from the garage floor to the garage wall. Additional details regarding example embodiments of CMS s which may be implemented herein are disclosed in U.S. Provisional App. No. 63/362,952, filed Apr. 13, 2022, and titled CABLE MANAGEMENT IN EV CHARGER SYSTEMS, which is incorporated herein by reference in its entirety for all purposes. In addition, some example details regarding the CMS are disclosed in and discussed with respect to FIGS. 4A-4D in the present disclosure.

In some embodiments, the system 100 may include multiple pairs of lead assemblies in which each pair electrically couples the power platform 102 to a different set of one or more charger platforms 106. Alternatively, or additionally, each pair of lead assemblies may electrically couple the power platform 102 to a different set of one or more EV chargers. For example, one pair of lead assemblies may electrically couple the power platform 102 to a first set of four EV chargers of a first charger platform 106, another pair of lead assemblies may electrically couple the power platform 102 to a second set of four EV chargers of a second charger platform 106, and

The charger platforms 106 may each include a pedestal base 108 and one or more EV chargers. The pedestal bases 108 may mechanically interface with the CMS 104 and the EV chargers. The pedestal bases 108 may permit the CMS 104 and the charger platforms 106 to be installed above-ground. In addition, the pedestal bases 108 may permit the CMS 104 to function as an above-ground wiring run.

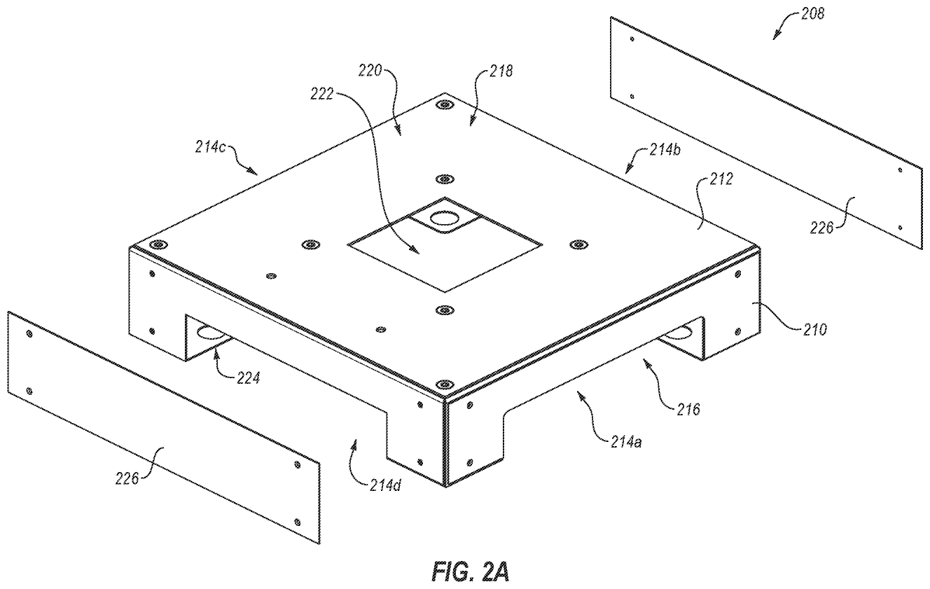

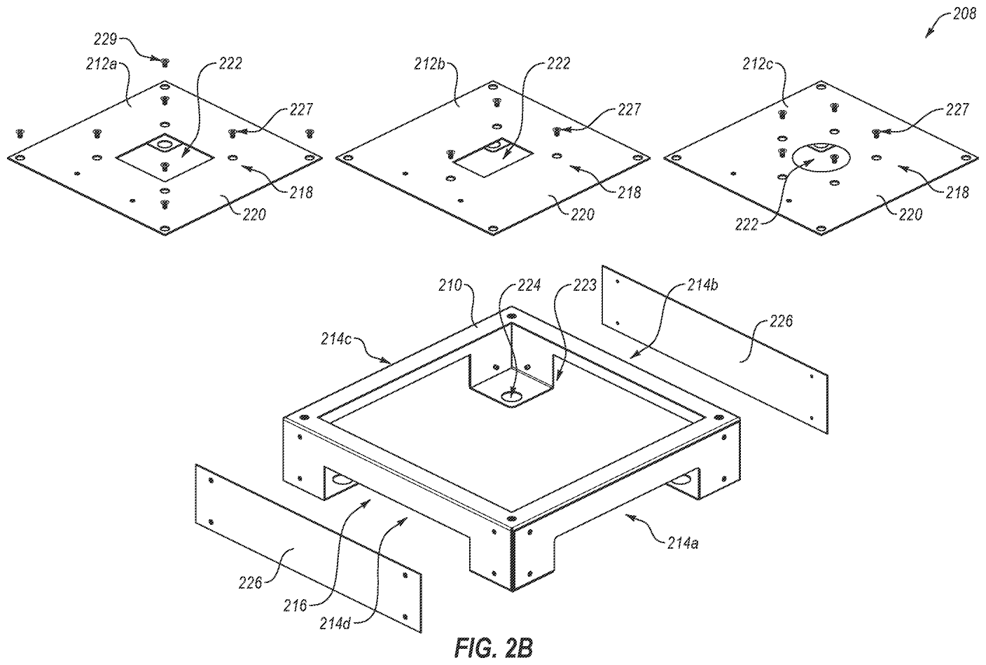

FIGS. 2A and 2B illustrate an example pedestal base 208 that may be implemented in the system 100 of FIG. 1, in accordance with at least one embodiment described in the present disclosure. FIG. 2A illustrates a perspective view of the pedestal base 208. FIG. 2B illustrates an exploded view of the pedestal base 208. The pedestal base 208 may correspond to the pedestal bases 108 described in relation to FIG. 1. For example, one or more of the pedestal bases 108 of FIG. 1 may have a similar or identical configuration as the pedestal base 208.

The pedestal base 208 may include a skid base 210 and multiple covers 212a-c (generally referred to in the present disclosure as “cover 212” or “covers 212”). In FIG. 2A, a single cover 212 is illustrated and denoted as 212 to show an example of the skid base 210 interfaced with the cover 212. As illustrated in FIG. 2B, the pedestal base 208 may include multiple covers 212. In use, the pedestal base 208 may be installed with a single cover 212 coupled to the skid base 210 in some embodiments. Thus, the pedestal base 208 including a skid base 210 and multiple covers 212 should be broadly construed to mean that the skid base 210 is configured to interface with any of multiple different covers 212. When installed, however, the pedestal base 208 may generally include the skid base 210 and at least one cover 212.

The skid base 210 may define a first opening 214a, a second opening 214b, a third opening 214c, and a fourth opening 214d (generally referred to in the present disclosure as “openings 214”). The skid base 210 may define a cover opening 223 (illustrated in FIG. 2B) and mounting openings 224. A single instance of the mounting openings 224 is denoted in FIGS. 2A and 2B for ease of illustration. The cover opening 223 is defined in a first side of the skid base 210 and the mounting openings 224 are defined in tabs or brackets of the skid base 210 at a second side of the skid base 210 opposite the first side. The first side may be referred to as the top side while the second side may be referred to as the bottom side. The pedestal base 208 may include one or more base plates 226. A single instance of the base plate 226 is illustrated in FIG. 2A for ease of illustration.

The skid base 210 may interface with and/or receive an end or other portion of the CMS (e.g., the CMS 104 of FIG. 1) via the openings 214. Alternatively, or additionally, the skid base 210 may interface with and/or receive an end or other portion of a raceway included in the CMS. The skid base 210 may interface with the CMS via any of the openings 214. For example, the skid as base 210 may interface with the CMS via the first opening 214a. Alternatively, or additionally, the skid base 210 may interface with multiple CMS s via the openings 214. For example, the skid base 210 may interface with a first CMS via the first opening 214a and a second CMS via the third opening 214c. The openings 214 may encase a portion of the interfaced CMS. For example, the openings 214 may include a complementary size and shape to that of the CMS (or portion thereof) such that the CMS may pass partially, substantially, or completely through the openings 214.

The covers 212 may be configured to mechanically interface with one or more EV chargers (not illustrated in FIGS. 2A and 2B). The covers 212 may mechanically interface with the EV chargers such that the EV chargers are physically positioned proximate a surface 220 of the covers 212. Alternatively or additionally, a given EV charger may be mechanically coupled to a corresponding one of the covers 212.

The covers 212 may mechanically interface with the skid base 210 to be physically positioned within and/or extending across at least a portion of the cover opening 223. Alternatively, the covers 212 may mechanically interface with the skid base 210 to be physically positioned proximate and/or extending partially or completely across the cover opening 223. The skid base 210 may define a volume 216. Alternatively, or additionally, the skid base 210 and the covers 212, when mechanically interfaced with the skid base 210 may define the volume 216.

The skid base 210 and the covers 212 may mechanically interface to permit a cable (e.g., a lead assembly) of the CMS (not illustrated in FIGS. 2A and 2B) to extend between the CMS and the EV charger. In addition, the skid base 210 and the covers 212 may mechanically interface to permit the cable of the CMS to extend through the opening 214 and the volume 216. For example, the skid base 210 may cover at least a portion of the CMS such that a portion of the cable may exit from the CMS within the volume 216 and extend to the EV charger mechanically interfaced with the cover 212. The skid base 210 may cover at least a portion of multiple CMS s such that a portion of cables within the CMS s may exit from the CMS s within the volume 216 and extend across the volume 216 to another CMS. The cable may include a lead assembly as illustrated in FIG. 4A of the present application and further described in U.S. Pat. No. 10,992,254 issued Apr. 27, 2021, and titled LEAD ASSEMBLY FOR CONNECTING SOLAR PANEL ARRAYS TO INVERTER, which is incorporated herein by reference in its entirety for all purposes.

Each of the covers 212 may define a mechanical interface 218 (generally referred to in the present disclosure as “mechanical interface 218” or “mechanical interfaces 218”). Each of the covers 212 are illustrated in FIGS. 2A and 2B as defining a single mechanical interface 218 for ease of illustration. Each of the covers 212 may define two or more mechanical interfaces to permit two or more EV chargers to mechanically interface with a single cover 212. For example, a first of the mechanical interfaces 218 may be complementary to and facilitate coupling the cover 212 to a first EV charger with a first mechanical interface while a second of the mechanical interfaces 218 may be complementary to and facilitate coupling the same cover 212 to a second EV charger with a second mechanical interface that is different than the first mechanical interface.

The mechanical interfaces 218 defined by the different covers 212 may correspond to different EV chargers. The different mechanical interfaces 218 may permit a different EV charger to be attached to the covers 212 proximate the corresponding surface 220. For example, the mechanical interface 218 of a first cover 212a may correspond to a first EV charger (or more generally to any EV chargers that have a first mechanical interface), the mechanical interface 218 of a second cover 212b may correspond to a second EV charger (or more generally to any EV chargers that have a second mechanical interface), and the mechanical interface 218 of a third cover 212c may correspond to a third EV charger (or more generally to any EV chargers that have a third mechanical interface). The mechanical interfaces 218 may include a charger opening 222 configured to permit the cable of the CMS to connect to the EV charger when mechanically interfaced proximate the surface 220.

The mechanical interfaces 218 may be defined to permit a charger platform (e.g., the charger platforms 106 of FIG. 1) to be located at an intersection of four parking stalls such that one or more EVs may charge from the charger platform.

The base plates 226 may mechanically interface with the skid base 210 proximate and/or across one or more of the openings 214. The base plates 226, when mechanically interfaced with the skid base 210, may prevent debris (e.g., rocks, garbage, etc.) from entering the volume 216. The base plates 226 may further define the volume 216 when mechanically interfaced with the skid base 210. Alternatively or additionally, the base plates 226 may be selectively removable from the skid base 210 to permit a technician to selectively access the volume 216 to service cables passing therethrough and/or for other reasons.

The pedestal base 208 may include one or more fasteners 227 (illustrated in FIG. 2B) (generally referred to in the present disclosure as “fasteners 227”) configured to mechanically interface with the corresponding mechanical interface 218 and the corresponding EV charger. More or fewer fasteners 227 may be used depending on the number of corresponding holes in a given mechanical interface 218 of a given cover 212 and corresponding EV charger. The fasteners 227 may mechanically couple the EV charger to the covers 212.

The pedestal base 208 may include one or more cover fasteners 229 (illustrated in FIG. 2B) (generally referred to in the present disclosure as “cover fasteners 229”). The cover fasteners 229 may mechanically interface with the covers 212 and the skid base 210 to cause the covers 212 to mechanically interface with the skid base 210. For example, the cover fasteners 229 may include a threaded shank extending from a head. The skid base 210 may include one or more welded on nuts, threaded through holes, threaded blind holes, or the like configured to mate with the cover fasteners 229. The cover fasteners 229 may compress a portion of the covers 212 (or of a single cover 212) between the head of a given cover fastener 229 and a portion of the skid base 210 to cause the covers 212 (or a single cover 212) to mechanically interface with the skid base 210.

The pedestal base 208 may be installed on various surfaces. For example, the pedestal base 208 may be affixed to a concrete pad, an asphalt surface such as a parking lot, the ground including grass, dirt, rock, etc., walls, and/or ceilings (e.g., concrete walls or ceilings of parking garages, drywall and/or wood walls or ceilings of homes, etc.). The pedestal base 208 may be affixed to the various surfaces using various mechanical fasteners (not illustrated in FIGS. 2A and 2B) configured to mate with the mounting openings 224. The mechanical fasteners may include, but are not limited to, screws, earth screws, masonry screws, bolts, lag bolts, anchors, concrete anchors, expanding anchors, nails, and the like.

Modifications, additions, or omissions may be made to the pedestal base 208 without departing from the scope of the present disclosure. For example, in some embodiments, the pedestal base 208 may include any number of other components that may not be explicitly illustrated or described. For example, the pedestal base 208 may include four or more covers 212. As another example, the pedestal base 208 may include three or more base plates 226.

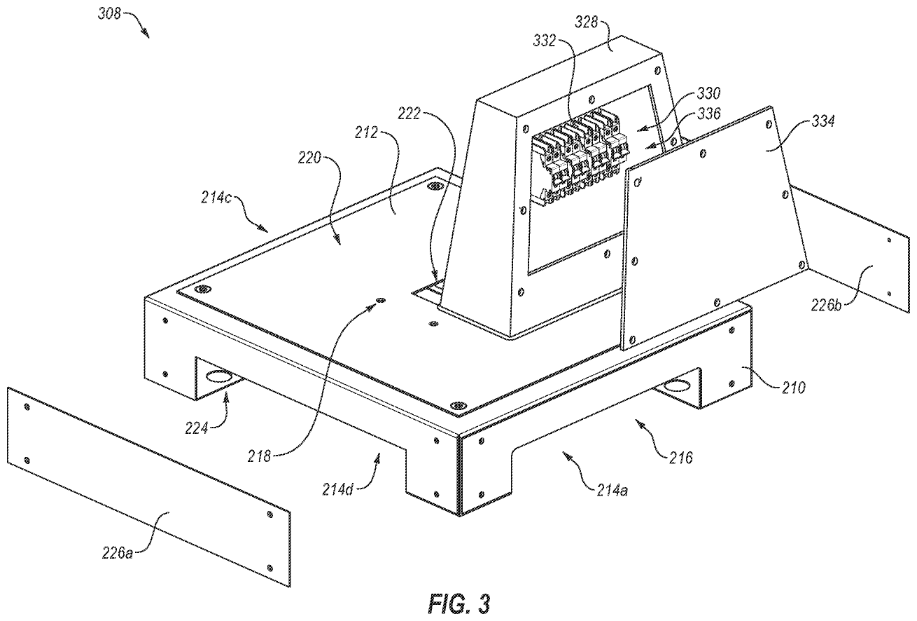

FIG. 3 illustrates another example pedestal base 308 that may be implemented in the system 100 of FIG. 1, in accordance with at least one embodiment described in the present disclosure. The pedestal base 308 may correspond to the pedestal bases 108 described in relation to FIG. 1. The pedestal base 308 may include an overcurrent device box 328, an overcurrent device 332, and an access plate 334. In FIG. 3, a single cover 212 is illustrated to show an example of the skid base 210 and the overcurrent device box 328 interfaced with the cover 212.

The overcurrent device 332 may be physically positioned (e.g., disposed) within a second volume 330 defined by the overcurrent device box 328. The overcurrent device box 328 may mechanically interface with each of the covers 212. The overcurrent device 332 may be configured to electrically couple to the EV charger and one or more cables of the CMS.

The overcurrent device 332 may electrically couple between the EV charger and the cable of the CMS. For example, a first end of the overcurrent device 332 may electrically couple to the cable of the CMS and a second end of the overcurrent device 332 may electrically couple to the EV charger (e.g., via an additional cable). The overcurrent device 332 is illustrated in FIG. 3 as including circuit breakers for exemplary purposes. The overcurrent device 332 may include one or more circuit breakers, fuse holders, electrical switches, fuses, or some combination thereof.

The overcurrent device 332 may include one or more devices that each include an open configuration and a closed configuration. In the open configuration, the devices may electrically decouple the EV charger from the cable of the CMS. In the closed configuration, the devices may electrically couple the EV charger to the cable of the CMS. In some embodiments, the overcurrent device 332 may be configured to protect the cable, the EV charger, or some combination thereof from a short circuit condition or an overcurrent condition, by tripping and disconnecting the cable from the EV charger.

Each device may be tripped (switched from closed to open) and/or reset (e.g., switched from open to closed) automatically or manually. For example, a device may trip automatically in response to the over current condition or the short circuit condition to prevent or reduce damage to the EV chargers or the EV(s) being charged and/or may be reset automatically when the over current condition or the short circuit condition is resolved. As another example, a device may be tripped manually by a person to inspect, service, or otherwise interact with the cable, the EV charger, the charger platforms, or some combination thereof downstream of the device, and may be reset manually by the person when finished with inspecting, servicing, or otherwise finished.

In some embodiments, the overcurrent device 332 may include one or more fuses that each include a closed state and a failed state. In the closed state and when installed, the fuses may electrically couple the EV charger to the cable of the CMS. In the failed state, the fuses may electrically decouple (e.g., isolate) the EV charger from the cable of the CMS. When the fuses are removed, the EV charger may be electrically decoupled from the cable of the CMS. In some embodiments, the fuses may be configured to protect the cable, the EV charger, or some combination thereof from a short circuit condition or an overcurrent condition, by blowing (e.g., failing) and disconnecting the cable from the EV charger.

Each fuse may be rated for a maximum current level. If a current flowing through a fuse exceeds the maximum current level (e.g., the over current condition), a portion of the fuse may overheat and may blow (e.g., melt) to create an open (e.g., the fuse may transition from the closed state to the failed state). The fuse may blow automatically in response to the over current condition to prevent or reduce damage to the EV chargers or the EV(s) being charged. In some embodiments, a fuse may be removed by a person to inspect, service, or otherwise interact with the cable, the EV charger, the charger platforms, or some combination thereof downstream of the fuse, and may be replaced by the person when finished with inspecting, servicing, or otherwise finished. If a fuse transitions to the failed state, the fuse may be removed by a person to inspect or otherwise interact with the cable, the EV charger, the charger platforms, or some combination thereof. The fuse may be replaced by a different fuse in the closed state.

The overcurrent device box 328 may define an access opening 336. The access opening 336 may permit access to the overcurrent device 332 disposed within the second volume 330. In addition, the access plate 334 may mechanically interface with the overcurrent device box 328 proximate the access opening 336. The access plate 334 may further define the second volume 330 when mechanically interfaced with the overcurrent device box 328.

FIGS. 4A-4C illustrate an example CMS 400, arranged in accordance with at least one embodiment described herein. The CMS 400 may include, be included in, or correspond to the CMS 104 of FIG. 1. FIGS. 4A, 4B, and 4C respectively include a top front perspective view, a bottom front perspective view, and an exploded top front perspective view of the CMS 400. As illustrated, the CMS 400 may include one or more multicable clips 402, one or more retention plates 404, a cable raceway 406 (which may include, be included in, or correspond to other raceways herein), and/or one or more risers 408. FIG. 4A additionally illustrates example feeder cables 410 that may be managed, protected, and/or housed by the CMS 400. The feeder cables 410 may be part of corresponding lead assemblies and/or may be the same as or similar to other feeder cables herein. Only one of the feeder cables 410 is labeled in FIG. 4A for simplicity. The feeder cables 410 are omitted from FIGS. 4B and 4C for clarity.

Each multicable clip 402 includes multiple channels to receive and secure multiple feeder cables 410. For example, each of the multicable clips 402 illustrated in FIGS. 4B and 4C includes five channels to receive and secure five feeder cables 410. FIG. 4D illustrates an alternative embodiment of a CMS 400A in which each multicable clip 402A includes eight channels to receive and secure eight feeder cables (not shown in FIG. 4D). More generally, the number of channels included in each multicable clip may be one or more, such as five or eight as illustrated in FIGS. 4B-4D, three, seven, ten, or other desired number of channels. Additionally, while each of the channels in the multicable clips 402 have been described as receiving and securing a single feeder cable 410 in each channel, more generally each channel may receive and secure one or more feeder cables 410, such as two feeder cables 410 per channel, three feeder cables 410 per channel, or other number of feeder cables per channel. The dimensions of each channel and/or feeder cable may be selected according to the number of feeder cables to be received in each channel. In these and other embodiments, the number of feeder cables 410 that may be included in the CMS 400 may be determined based on the National Electric Code. The retention plates 404 or 404A may couple to the multicable clips 402 or 402A to retain the feeder cables 410 in the channels after placement therein. As illustrated, each of the multicable clips 402, 402A may be stacked with another multicable clip 402, 402A through the risers 408, 408A. The risers 408, 408A may couple the multicable clips 402, 402A together (optionally with one or more threaded fasteners or other fasteners).

A set of stacked multicable clips 402, 402A together with corresponding retention plates 404, 404A and risers 408, 408A (and optional fasteners) may be referred to herein as a stacked retention assembly 412, 412A. Two stacked retention assemblies 412 are at least partially visible in each of FIGS. 4B and 4C and one stacked retention assembly 412A is visible in FIG. 4D. The stacked retention assemblies 412, 412A may be spaced apart along a length of the cable raceway 406, 406A to provide support and management of the feeder cables 410 along the length of the cable raceway 406, 406A. For example, the stacked retention assemblies 412, 412A may be spaced every eighteen to twenty-four inches. By stacking multiple multicable clips 402, 402A together, each stacked retention assembly 412, 412A may secure in a single location along the length of the cable raceway 406, 406A more feeder cables 410 than a single multicable clip 402, 402A by itself. The illustrated embodiment of FIGS. 4A-4C depicts ten feeder cables 410 secured by each of the stacked retention assemblies 412 which is twice as many as one of the multicable clips 402 alone. Similarly, in the embodiment of FIG. 4D, the stacked retention assembly 412A may secure sixteen feeder cables (assuming there is one feeder cable per channel), which is twice as many as one of the multicable clips 402A alone.

Within each stacked retention assembly 412, 412A, one of the multicable clips 402, 402A will be closer to and/or coupled directly to an installation surface 414 while the other multicable clip(s) 402, 402A is(are) spaced further from the installation surface 414. The multicable clip 402 that is closest to and/or coupled directly to the installation surface 414 may be referred to herein as a base multicable clip 402, 402A. The multicable clip(s) 402, 402A that is(are) spaced further from the installation surface 414 than the base multicable clip 402, 402A may be referred to herein as the elevated multicable clip(s) 402, 402A because it is spaced apart from or elevated relative to the installation surface 414. The use of “base” and “elevated” in describing the multicable clips 402, 402A in stacked retention assemblies 412, 412A should not be construed to require that the stacked retention assemblies 412, 412A have a particular orientation relative to any given reference frame. Rather, the use of “base” and “elevated” in describing the multicable clips 402, 402A in stacked retention assemblies 412, 412A is merely used as an aid in distinguishing between the multicable clips 402, 402A in a stacked retention assembly 412, 412A notwithstanding any particular orientation they may have relative to a given reference frame. In FIG. 4C, the installation surface 414 may be a floor or ground (i.e., gravity is down in the orientation of FIG. 4C) such that the multicable clip 402 at the bottom of each stacked retention assembly 412 is the base multicable clip 402 while the other multicable clip 402 in each stacked retention assembly 412 is the elevated multicable clip 402. If the installation surface 414 were instead a ceiling surface (i.e., gravity is up in the orientation of FIG. 4C), the multicable clip 402 that is closest to the installation surface 414 would still be referred to as the base multicable clip 402 and the multicable clip 402 that is furthest from the installation surface 414 would still be referred to as the elevated multicable clip 402 despite being lower than the base multicable clip relative to the gravitational reference frame.

The cable raceway 406, 406A may be configured to engage at least one of the multicable clips of each stacked retention assembly 412, 412A along its length to enclose the stacked retention assemblies 412, 412A at least partially (or portions thereof) and the feeder cables 410. For example, a retention flange or other structure of the cable raceway 406, 406A may be configured to engage a shoulder or other structure defined in a bottom of each base multicable clip 402, 402A.

Substitutions, modifications, additions, etc. may be made to FIGS. 4A-4D without altering the scope of the disclosure. For example, the CMS 400, 400A may have a single multicable clip 402, 402A and retention plate 404, 404A at each supported location along the length of the feeder cables 410 instead of a stacked retention assembly 412, 412A. Alternatively or additionally, while a height of the cable raceway 406, 406A is illustrated as accommodating a base multicable clip 402, 402A and one elevated multicable clip 402, 402A, the height of the cable raceway 406, 406A may be reduced to accommodate a single multicable clip 402, 402A (e.g., a base multicable clip 402, 402A without any elevated multicable clips 402, 402A) or increased to accommodate three or more multicable clips 402, 402A (e.g., a base multicable clip 402, 402A with two or more elevated multicable clips 402, 402A) in a given stacked retention assembly 412, 412A.

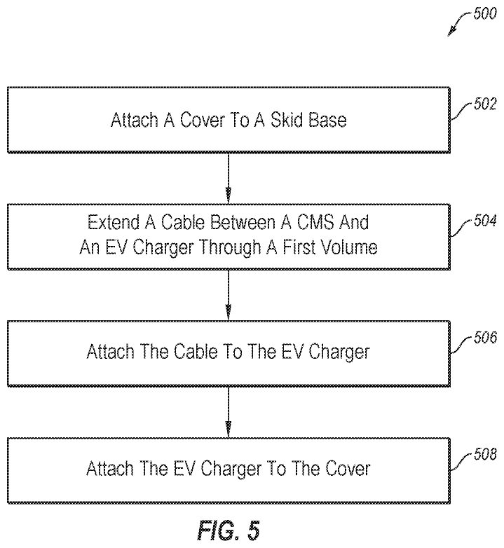

FIG. 5 illustrates a flowchart of an example method 500 of assembling a pedestal base, in accordance with at least one embodiment described in the present disclosure. In some embodiments, assembling the pedestal base may include attaching a cover to a skid base and attaching an EV charger to the pedestal base. The method 500 may be performed to assemble any suitable pedestal base. For example, the method 500 may be performed to assemble the pedestal bases 108 of FIG. 1, the pedestal base 208 of FIG. 2, or the pedestal base 308 of FIG. 3. The method 500 may include one or more blocks 502, 504, 506, or 508. Although illustrated with discrete blocks, the steps and operations associated with one or more of the blocks of the method 500 may be divided into additional blocks, combined into fewer blocks, or eliminated, depending on the particular implementation.

At block 502 a cover may be attached to a skid base. The skid base and the cover may define a first volume. For example, the cover 212 of FIGS. 2A-3 may be attached to the skid base 210 of FIGS. 2A-3 and may define the volume 216.

At block 504, a cable may be extended between a CMS and an EV charger. The cable may be extended through the first volume. For example, the cable may extend through the volume 216 defined by the skid base 210 and the cover 212. At block 506, the cable may be attached to the EV charger. At block 508, the EV charger may be attached to the cover. For example, the EV charger may be attached to the cover 212 to be physically positioned proximate the surface 220 of the cover 212.

In some embodiments, the method 500 may include additional steps and/or operations. For example, the method 500 may also include interfacing the skid base with the CMS. The skid base may define an opening and the skid base may interface with the CMS via the opening. As another example, the method 500 may include attaching the skid base to a ground surface. The skid base may be attached to the ground surface to permit the skid base, the cover, and the CMS to be physically positioned above-ground and the CMS to function as an above-ground wiring run.

In some embodiments, the pedestal base may include an overcurrent device box that includes an overcurrent device. The overcurrent device box may define a second volume. In these and other embodiments, the method 500 may include disposing the overcurrent device within the second volume. The overcurrent device 332 of FIG. 3 may be disposed within the second volume 330 defined by the overcurrent device box 328 of FIG. 3. Additionally, the method 500 may include attaching the overcurrent device box to the cover. In these and other embodiments, block 504 may include electrically coupling the EV charger to the overcurrent device. In these and other embodiments, block 504 may also include electrically coupling the cable to the overcurrent device.

In some embodiments, the skid base may define another opening. In these and other embodiments, the method 500 may also include attaching an access plate to the overcurrent device box proximate the access opening. In addition, the method 500 may include attaching a base plate to the skid base proximate the fourth opening.

Modifications, additions, or omissions may be made to the method 500 without departing from the scope of the present disclosure. For example, the operations of method 500 may be implemented in differing order. Alternatively, or additionally, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A pedestal base comprising:
a skid base defining an opening, the skid base configured to interface with a cable management system (CMS) via the opening; and
a cover configured to:
mechanically interface with an electric vehicle (EV) charger; and
mechanically interface with the skid base, wherein:
the skid base and the cover define a volume; and
the skid base and the cover, when mechanically interfaced, permit a cable to extend between the CMS and the EV charger and to extend through the opening and the volume.

2. The pedestal base of claim 1, wherein the cover defines a mechanical interface configured to permit the cover and the EV charger to mechanically interface.

3. The pedestal base of claim 2 further comprising a fastener configured to mechanically interface with the mechanical interface and the EV charger to mechanically couple the EV charger to a surface of the cover.

4. The pedestal base of claim 1 further comprising an overcurrent device box configured to mechanically interface with the cover, the overcurrent device box comprising an overcurrent device configured to electrically couple to the EV charger and the cable.

5. The pedestal base of claim 4, wherein the overcurrent device comprises one or more of a circuit breaker or a fuse holder.

6. The pedestal base of claim 4, wherein the overcurrent device is configured to transition between an open configuration and a closed configuration, wherein in the open configuration, the overcurrent device is configured to electrically isolate the EV charger from the cable, and in the closed configuration, the overcurrent device is configured to electrically couple the EV charger to the cable.

7. The pedestal base of claim 1, wherein the skid base is configured to mechanically interface with the CMS comprising a raceway comprising a base with a cover portion coupled to the base that forms one or more channels to receive the cable.

8. The pedestal base of claim 1, wherein the opening is configured to encase a portion of the CMS.

9. The pedestal base of claim 1, wherein the skid base is configured to mechanically interface with the CMS to permit the skid base and the CMS to be installed above-ground and the CMS to function as an above-ground wiring run.

10. The pedestal base of claim 1 further comprising a fastener configured to mechanically couple the cover to the skid base.

11. The pedestal base of claim 1, wherein the cover is configured to mechanically interface with the EV charger comprising a pedestal.

12. The pedestal base of claim 1, wherein the cover defines a plurality of mechanical interfaces and is configured to mechanically interface with a plurality of EV chargers having different mechanical interfaces, each complementary to a different one of the plurality of mechanical interfaces.

13. The pedestal base of claim 1, wherein:
the CMS comprises a first CMS;
the cable comprises a first cable; and
the skid base further defines another opening, the skid base configured to interface with a second CMS via the another opening, wherein the skid base permits a second cable to extend between the first CMS and the second CMS.

14. A pedestal base comprising:
a plurality of covers, each cover of the plurality of covers comprising a different mechanical interface configured to permit a different electric vehicle (EV) charger to be attached to a surface of a corresponding cover of the plurality of covers; and
a skid base defining an opening, the skid base configured to interface with a cable management system (CMS) via the opening and each cover of the plurality of covers configured to mechanically interface with the skid base, wherein:
the skid base and each cover of the plurality of covers, when mechanically interfaced, define a volume; and
the skid base and each cover of the plurality of covers, when mechanically interfaced, permit a cable to extend between the CMS and the EV charger and to extend through the opening and the volume.

15. The pedestal base of claim 14 further comprising an overcurrent device box configured to mechanically interface with each cover of the plurality of covers, the overcurrent device box defining a second volume and comprising an overcurrent device configured to electrically couple to the EV charger and the cable.

16. The pedestal base of claim 14, wherein the skid base is configured to interface with the CMS to permit the skid base and the CMS to be installed above-ground and the CMS to function as an above-ground wiring run.

17. The pedestal base of claim 14, wherein each cover of the plurality of covers is configured to mechanically interface with a different EV charger with a built-in pedestal.

18. A method comprising:
attaching a cover to a skid base, the skid base and the cover defining a first volume;
extending a cable between a cable management system (CMS) and an electric vehicle (EV) charger through the first volume;
attaching the cable to the EV charger; and
attaching the EV charger to the cover.

19. The method of claim 18 further comprising:
interfacing the skid base with the CMS via an opening defined by the skid base;
disposing an overcurrent device within a second volume defined by an overcurrent device box;
attaching the overcurrent device box to the cover, wherein extending the cable between the CMS and the EV charger comprises:
electrically coupling the EV charger to the overcurrent device; and
electrically coupling the cable to the overcurrent device; and
attaching the skid base to a ground surface to permit the skid base, the cover, and the CMS to be physically positioned above-ground and the CMS to function as an above-ground wiring run.

20. The method of claim 19, the overcurrent device box defining an access opening positioned proximate the overcurrent device and the skid base defining another opening, the method further comprising:
attaching an access plate to the overcurrent device box proximate the access opening; and
attaching a base plate to the skid base proximate the another opening.
